(19) United States
(12) Patent Application Publication
(10) Pub. No.: US 2026/0097317 A1
(43) Pub. Date: Apr. 9, 2026

(54) RACING SIMULATION USING FORCE FEEDBACK AT STEERING WHEEL

(71) Applicant: Lenovo (United States) Inc., Morrisville, NC (US)

(72) Inventors: James LaCroix, Morrisville, NC (US); Nicolas Allebrodt, Morrisville, NC (US); Axel Ramirez, Morrisville, NC (US)

(21) Appl. No.: 18/908,506

(22) Filed: Oct. 7, 2024

(51) Int. Cl. A63F 13/803

(52) U.S. Cl. CPC A63F 13/803; A63F 2300/8017

(57) ABSTRACT

In one aspect, a device includes a processor system and storage accessible to the processor system. The storage includes instructions executable by the processor system to facilitate a racing simulation and, as part of facilitating the racing simulation, adapt force feedback at a steering wheel input device in real time as the racing simulation transpires. The force feedback is adapted in real time based on one or more variable inputs associated with the racing simulation.

### FIELD

The disclosure below relates to technically inventive, non-routine solutions that are necessarily rooted in computer technology and that produce concrete technical improvements. In particular, the disclosure below relates to improved racing simulations using force feedback at a steering wheel.

### BACKGROUND

As recognized herein, current input and output modalities related to computer simulations are limited and can be improved.

### SUMMARY

Accordingly, in one aspect a device includes a processor system and storage accessible to the processor system. The storage includes instructions executable by the processor system to facilitate a racing simulation and, as part of facilitating the racing simulation, adapt force feedback at a steering wheel input device in real time as the racing simulation transpires. The force feedback is adapted in real time based on one or more variable inputs associated with the racing simulation.

In various example implementations, the instructions may be executable to adapt the force feedback at the steering wheel input device in real time as the racing simulation transpires by reducing radial force feedback at the steering wheel input device and/or increasing radial force feedback at the steering wheel input device.

In various examples, the one or more variable inputs may include simulation vehicle velocity. Additionally or alternatively, the one or more variable inputs may include simulation vehicle tire traction, such as tire slippage and/or tire drifting. Still further, the one or more variable inputs may include one or more simulation road conditions, such as an asphalt road condition, a gravel road condition, a wet surface road condition, and/or an icy surface road condition. If desired, the one or more variable inputs may further include one or more real-world driver biometrics, such as heart rate, oxygen level, pupil dilation, and/or body temperature. In some cases, the one or more variable inputs may even include simulation weather, such as simulation wind impinging upon a simulation vehicle controlled by the steering wheel input device and/or simulation precipitation impinging upon the simulation vehicle controlled by the steering wheel input device.

In some example embodiments, the device may include one or both of an electronic headset on which visual content related to the racing simulation is presented, and an electronic race car in which a person can sit while playing the racing simulation.

In another aspect, a method includes facilitating a racing simulation at a device and, as part of facilitating the racing simulation, adapting force feedback at a steering wheel input device as the racing simulation transpires. The force feedback is adapted during execution of the simulation based on one or more variable inputs associated with the racing simulation.

In one example, the one or more variable inputs may include one or more real-world biometrics of a person. So here, the method may include identifying, based on the one or more real-world biometrics of the person, a stress level of the person in participating in the racing simulation. The method may then include reducing, based on the stress level of the person participating in the racing simulation, radial force feedback at the steering wheel input device.

In still another aspect, at least one computer readable storage medium (CRSM) that is not a transitory signal includes instructions executable by a processor system to facilitate a racing simulation at a device. The instructions are also executable to, as part of facilitating the racing simulation, change force feedback at a steering wheel input device as the racing simulation transpires, the force feedback being changed during execution of the simulation based on one or more variable inputs associated with the racing simulation.

In one example embodiment, the one or more variable inputs may include one or more real-world biometrics of a person participating in the racing simulation. Here, the instructions may then be executable to increase, based on the one or more real-world biometrics of the person participating in the racing simulation, radial force feedback at the steering wheel input device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 is a block diagram of an example extended reality (XR) headset consistent with present principles;

FIG. 4 is a perspective view illustration of an example electronic race car in which a user can sit while playing a racing simulation consistent with present principles;

FIG. 5 shows example logic in example flow chart format that may be executed during a racing simulation to apply radial force feedback at a steering wheel used to provide input to a racing simulation consistent with present principles;

FIG. 6 shows example logic in example flow chart format that may be used to configure a machine learning (ML) model consistent with present principles;

FIG. 7 shows example software architecture that may be implemented consistent with present principles;

FIG. 8 shows an example graphical user interface (GUI) that may be presented to a user to indicate how the user might improve the user’s simulation race performance using a haptic steering wheel consistent with present principles; and

FIG. 9 shows an example GUI that may be presented to configure one or more settings of a device, app, and/or hardware race car simulator to operate consistent with present principles.

### DETAILED DESCRIPTION

Among other things, the detailed description below describes devices and methods that connect racer biometrics and sensor data to provide a next generation AR/VR racing simulation experience. Thus, a cutting-edge, no-latency AR/VR racing simulation experience is provided with the use of sensors fused with racer biometrics data using artificial intelligence and/or deep learning. In one specific example, a convolutional neural network (CNN) and deep learning algorithm/deep learning approach may be used for multimodal biometric and sensor recognition.

Sensors that may be involved include vitals biometric sensor(s) on the wrist, camera(s) for eye tracking inside the virtual headset, and microphones for voice control.

The user may thus feel every turn with the direct drive force feedback, providing unparalleled realism to the user’s steering.

Motion controls may also be used, with a tactical and haptic feedback system fused with racer biometrics data using AI/deep learning.

Additionally, race control real-time telemetry may be fused with racer biometrics data, voice commands, and eye positioning. Human real-time vitals monitoring may be used consistent with present principles (e.g., heart rate, oxygen levels, pupil dilation, body temperature).

As mentioned above, use cases include not just gaming but training, educational (e.g., totally virtual), deliveries, simulations of real life activities, etc. (part real life, part virtual).

In one particular aspect, an advanced adaptive force feedback system may continuously adapt force feedback at an electronic steering wheel in real-time based on a comprehensive array of simulation parameters, including vehicle velocity, tire traction, road conditions, and driver inputs. This dynamic adjustment ensures the feedback not only achieves a higher degree of realism but is also specifically tailored to each discrete moment of the driving experience. By incorporating a multi-layered tactile feedback mechanism, the system delivers an unprecedented level of detail in the tactile sensations transmitted to the driver, faithfully replicating the feel of diverse road surfaces (e.g. asphalt, gravel, wet conditions), tire slippage, and the impact of environmental factors like precipitation or wind. Recognizing drivers’ unique physical limitations, preferences and sensitivities, the system facilitates customizable feedback profiles (e.g., via biometric feedback) enabling users to modulate the intensity and characteristics of the force feedback to optimally align with their personal training objectives and comfort thresholds as well as physical limitations.

Thus, to further augment the training and immersive experience, the system can integrate with biometric sensors, dynamically modulating feedback based on the driver’s physiological responses, such as heart rate and stress indices. This biometric integration allows for tailoring the difficulty and intensity of the simulation to better accommodate the driver's physical state, fostering a more gradual and effective learning curve.

Applications and benefits include professional motorsports organizations employing this system as an elite training aid, providing teams and drivers a remarkably accurate and realistic platform for off-track preparation, enabling meticulous practice sessions that closely mirror real-world conditions without incurring the associated costs and risks. Automotive engineers and designers can harness this sophisticated simulation environment to virtually evaluate and refine the subjective feel of steering systems and vehicle dynamics, accelerating the development cycle for new technologies. Driving instructors can leverage the system’s capabilities to provide a safe, controlled environment for imparting advanced driving techniques, while individuals with physical disabilities can experience the joy of driving through an accessible and customizable virtual platform.

The advanced adaptive force feedback system disclosed herein therefore represents a transformative leap in sim racing technology, delivering an unparalleled degree of realism and immersion. The system thus elevates the sim racing experience for enthusiasts and professionals alike while concurrently forging new avenues for elite training, education, accessibility, and next-generation automotive research and development initiatives.

Example use-cases include: Training for professional motorsports; Providing ultra-realistic off-track training for race teams and drivers; Enabling detailed practice replicating real-world conditions and vehicle dynamics; Allowing honing skills without associated costs and risks of on-track sessions; Driving education and skill development; Safe, controlled virtual environment for teaching advanced driving techniques; Enhancing learning by delivering authentic physical feedback cues; Helping build better comprehension of vehicle behavior and dynamics; Accessibility for disabled driving enthusiasts; Customizable physical feedback tailored to individual needs; Allowing disabled individuals to experience driving thrills virtually; Promoting inclusivity by making sim racing more accessible; Automotive research and development; High-fidelity simulation platform for evaluating steering feel; Testing vehicle dynamics and new technologies in a virtual space; Accelerating innovation by shortening physical prototyping cycles; Enhancing sim racing for professionals and enthusiasts; Providing an unprecedented level of realism and immersion that elevates the experience; Customizing feedback profiles to suit personal preferences; and consistent high-quality force feedback across all sim racing setups.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

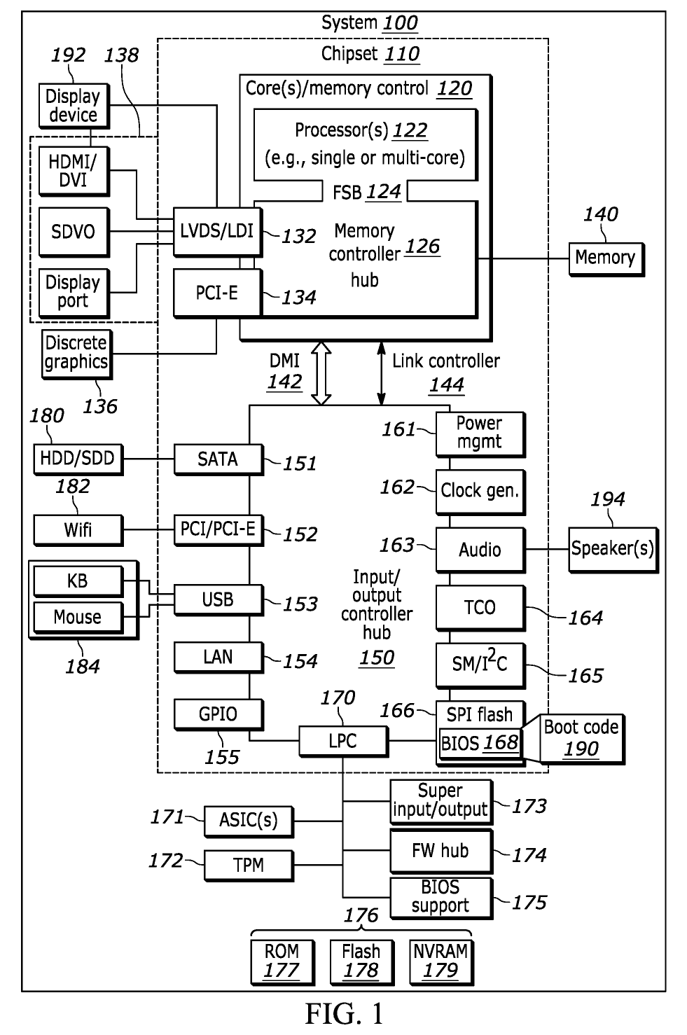

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

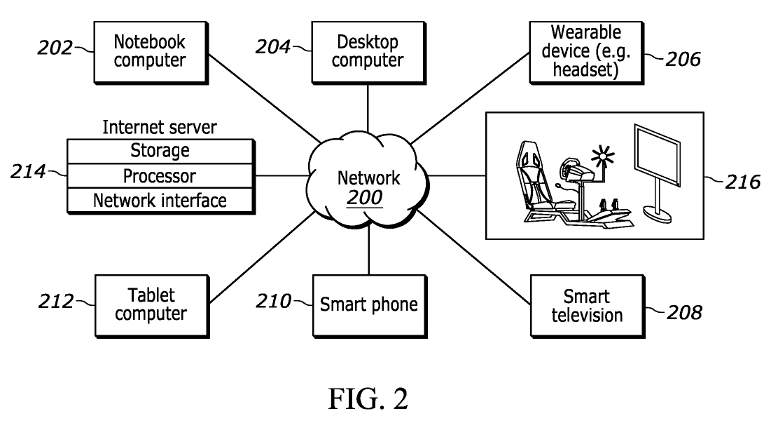

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch or XR headset, a smart television (TV) 208, a smart phone 210, a tablet computer 212, an electronic race car 216 in which a user can sit while playing a racing simulation, and a server 214 such as an Internet server that may provide cloud storage accessible to the devices 202-212, 216. It is to be understood that the devices 202-216 may be configured to communicate with each other over the network 200 to undertake present principles.

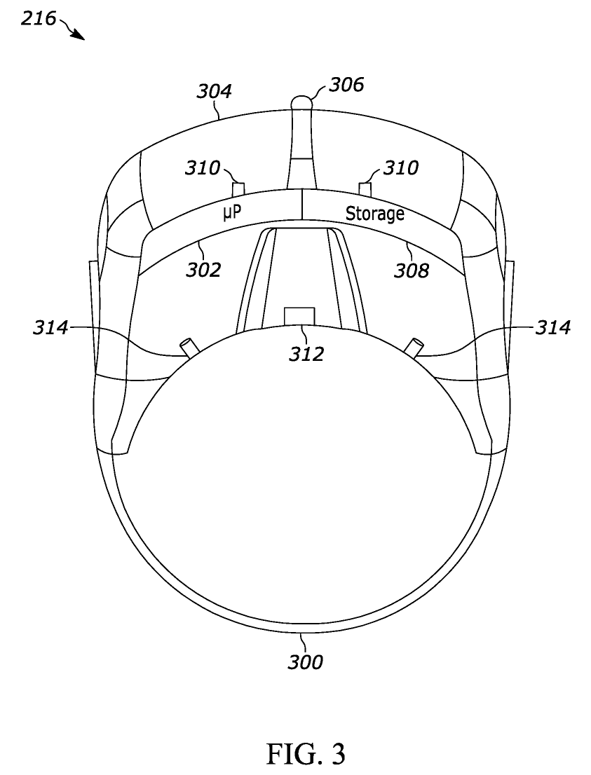

Now describing FIG. 3, it shows a top plan view of a headset such as the headset 206 consistent with present principles. The headset 206 may be used to present audio and/or video of the racing simulation at the headset’s speakers and display while other input/output is provided via the electronic race car 216.

The headset 206 may include a housing 300, at least one processor assembly 302 in the housing 300, and a non-transparent or transparent “heads up” display 304 accessible to the at least one processor assembly 302 and coupled to the housing 300. The display 304 may for example have discrete left and right eye pieces as shown for presentation of stereoscopic images and/or 3D virtual images/objects using augmented reality (AR) software, virtual reality (VR) software, and/or mixed reality (MR) software (more generally, extended reality (XR) software). The display 304 may thus present visual content related to the racing simulation.

The headset 206 may also include one or more forward-facing cameras 306. As shown, the camera 306 may be mounted on a bridge portion of the display 304 above where the user’s nose would be so that it may have an outward-facing field of view similar to that of the user himself or herself while wearing the headset 206. The camera 306 may be used for computer vision, image registration, spatial mapping, etc. to identify biometrics and other data and/or to track user movements within real-world space. However, further note that the camera(s) 306 may be located at other headset locations as well. Further note that in some examples, inward-facing cameras 310 may also be mounted within the headset 206 and oriented to image the user’s eyes for eye tracking while the user wears the headset 206 consistent with present principles.

Additionally, the headset 206 may include storage 308 accessible to the processor assembly 302 and coupled to the housing 300, a microphone 312 for detecting audio of the user speaking to provide voice commands to the racing simulation and detecting audio biometric data consistent with present principles (e.g., detecting excitement or stress in the user’s voice). The headset 206 may include additional biometric sensors 314 as well, such as a heart rate sensor, an oxygen level sensor, and/or a body temperature sensor.

The headset 206 may include still other components not shown for simplicity, such as a network interface for communicating over a network such as the Internet and a battery for powering components of the headset 206 such as the camera(s) 306. The headset 206 may also include one or more speakers for presenting audio of the racing simulation. Additionally, note that while the headset 206 is illustrated as a head-circumscribing VR headset, it may also be established by computerized smart glasses or another type of headset including other types of AR and MR headsets. For example, the headset may be established by an AR headset that may have a transparent display that is able to present 3D virtual objects/content.

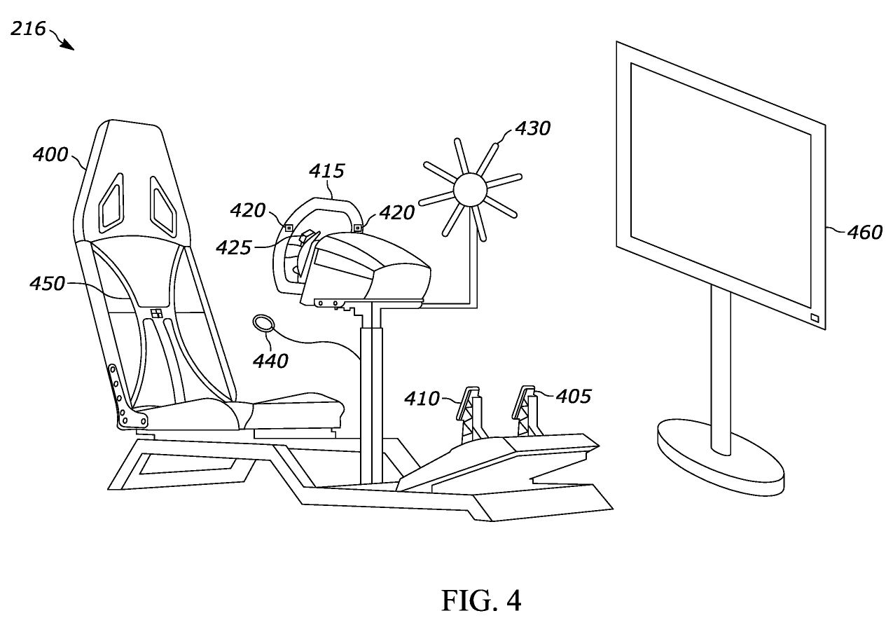

As mentioned above, the headset 206 may also communicate with the electronic race car 216 and/or a remotely-located server such as the server 214 to execute/facilitate a racing simulation consistent with present principles. The race car 216 is shown in greater detail in FIG. 4. As shown in this figure, the race car 216 may include a seat 400 in which a user can sit. The electronic race car may also include an electronic gas pedal 405 and an electronic brake pedal 410, either of which may be pushed forwards and released backwards by the user using his/her foot to either accelerate or decelerate/brake a virtual vehicle being controlled by the user as part of the racing simulation (via control of the real-life electronic pedals 405, 410). The pedals 405, 410 may thus include one or more sensors such as infrared (IR) proximity sensors, potentiometers, pressure sensors, position sensors, etc. to sense movement of the pedals 405, 410 to thus provide associated input to the racing simulation.

As also shown in FIG. 4, an electronic steering wheel input device 415 may also be included on the device 216. The steering wheel input device may include one or more vibrators 420 at different locations on the steering wheel 415 to create haptic/force feedback consistent with present principles, both radially according to the circular shape of the steering wheel to provide resistance in a direction opposite a direction in which the user turns the steering wheel input device 415, as well as obliquely and orthogonally to vibrate the steering wheel input device 415 back and forth in directions oblique and orthogonal to the radial plane (plane in which the radial curve of the circular, ovular, or semi-circular/ovular steering wheel resides). Each vibrator 420 may be established by, for example, an electric motor connected to an off-center and/or off-balanced weight via the motor’s rotatable shaft so that the shaft may rotate under control of the motor (which in turn may be controlled by a processor assembly such as the assembly 122) to create resistance and vibration of various frequencies and/or amplitudes and in various directions.

The steering wheel 415 may also include a potentiometer 425 or other type of sensor to sense turning of the steering wheel 415 while the user plays the racing simulation.

As also shown, the device 216 may include one or more electronic fans 430 including respective motors controllable by the device to increase and decrease the speed of the fans 420 to create wind proportional to a speed of a virtual race car being controlled by the user as part of the racing simulation to thus simulate wind that might be experienced by a real-life racer while racing. Other devices to similarly generate air flow may also be used.

The device 216 may further include a wired or wireless wearable device 440 that may be engaged with a user’s wrist or other body part to sense one or more biometrics of the user. Thus, the device 440 may include a heart rate sensor, an oxygen level sensor, a body temperature sensor, and/or another type of sensor for providing biometric input to a system operating consistent with present principles.

As also shown in FIG. 4, the device 216 may include a five-point active, electronic seatbelt tensioner 450 that anchors to the seat 400 at five respective locations, such as above each shoulder, to the side of each hip, and in between the legs. Each anchor point of the seatbelt 450 may be coupled to a motorized spool that can extend and retract the respective strap segment for that anchor point under control of a processor system consistent with present principles. Thus, each of the five straps of five-point tensioner 450 may be independently extendable via a respective spool to decrease tension of the strap against the user, and independently retractable via the respective spool to increase tension of the strap against the user, when the user is sitting in the seat 400 between the seatback and seat base and the straps themselves.

As also shown in FIG. 4, the device 216 may include a display 460 on which visual content may be presented. The visual content may include real-time video of the racing simulation as well as the GUIs described below. Note that the headset display may additionally or alternatively present the same content.

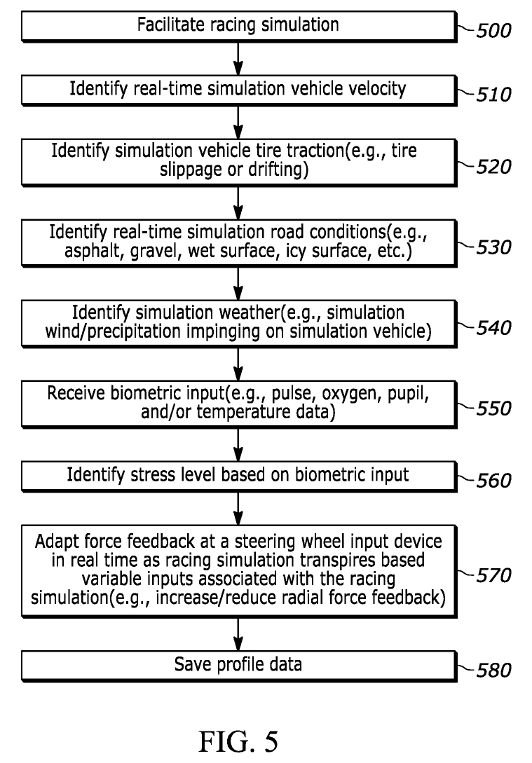

With FIGS. 1-4 having been described, it is to be understood that a user’s experience in a vehicle racing simulation may be enhanced through operations performed by a device/system, which may include a processor executing a set of codes to control functional elements of a real-life racing apparatus such as the e-vehicle 216. Accordingly and now referring now to FIG. 5, it shows example logic that may be executed by a device such as the system 100, headset 206, server 214, and/or electronic race car 216 alone or in any appropriate combination consistent with present principles. Note that while the logic of FIG. 5 is shown in flow chart format, other suitable logic may also be used.

Beginning at block 500, the device may facilitate (e.g., execute) a virtual racing simulation where a person/end-user races a first virtual race care (more generally, first simulation vehicle) against other virtual race cars on a virtual race track. The other race cars might be controlled by other human players/users, and/or autonomously by the simulation system itself. From block 500 the logic may then proceed to identify one or more variable inputs to the racing simulation, beginning at block 510.

At block 510 the device may, based on physis data from a simulation engine being run to execute the simulation, identify the real-time simulation vehicle velocity of the first simulation vehicle as the first simulation vehicle races along the racetrack as controlled by the end-user.

From block 510 the logic may proceed to block 520. At block 520 the device may identify real-time tire traction for the first simulation vehicle based on physics data from the simulation engine. Thus, the simulation engine might provide physics data at various times in the race that indicates tire slippage or tire drifting of the first simulation vehicle rather than tire gripping of the virtual racetrack surface.

After block 520 the logic may proceed to block 530. At block 530 the device may identify, based on data from the simulation engine, one or more real-time simulation road conditions that might change throughout the race. Those conditions might include whether the first simulation vehicle is currently on a simulation asphalt road forming part of the virtual racetrack or a simulation gravel (equivalently, dirt) road forming part of the racetrack. Additionally or alternatively, these conditions may include other things that might change over the course of the virtual race, such as a wet surface road condition or an icy surface road condition (equivalently, a snowy or frozen surface road condition), which might occur due to virtual precipitation during the virtual race.

From block 530 the logic may then proceed to block 540. At block 540, the device may identify any current, real-time simulation weather based on data from the simulation engine, with it being further noted that the weather may change over the course of the virtual race from sunny to rainy (or other precipitation) and back to sunny (or cloudy) again. Thus, in one example the simulation weather may include simulation wind impinging upon the first simulation vehicle (as being controlled by the end-user using the steering wheel input device). Additionally or alternatively, the simulation weather may include simulation precipitation impinging upon the simulation vehicle.

After block 540 the logic may then proceed to block 550. At block 550 the device may identify/receive biometric input as received from one or more biometric sensors that sense real-time, real-world driver biometrics of the end-user as the end-user controls the first simulation vehicle during the racing simulation. In various examples, the one or more real-world driver biometrics may include, but are not limited to, heart rate, oxygen level, pupil dilation, and/or body temperature.

The logic may then move to block 560 where the device may process the received input from the biometric sensors to subsequently provide one or more outputs/inferences about the end-user themselves based on the user’s biometrics, such as whether the end-user is stressed whilst participating in the racing simulation. The device may thus analyze the biometric data from the user using a stress estimation algorithm, a convolutional neural network (CNN), and/or other type of artificial intelligence-based model. Other user conditions may also be identified additionally or in the alternative but still based on the user’s biometrics, such as the user being calm (in which case force feedback resistance to turning at the steering wheel input device might be increased, rather than being decreased responsive to the user being identified as being stressed).

From block 560 the logic may then proceed to block 570. At block 570 the device may, as part of facilitating the racing simulation, adapt or otherwise change force feedback at the steering wheel input device in real time as the racing simulation transpires. The force feedback may therefore be adapted in real time based on the one or more variable inputs associated with the racing simulation as identified at blocks 510-550. Thus, in various examples, at block 570 the device may adapt the force feedback at the steering wheel input device in real time as the racing simulation transpires by reducing radial force feedback at the steering wheel input device and/or increasing radial force feedback at the steering wheel input device.

Thus, in some non-limiting instances, the amount of force feedback resisting the user turning the steering wheel radially in one direction or the other (to the left or right) may be dynamic such that it incrementally increases and decreases over time throughout the same racing simulation based on the user’s stress level respectively decreasing or increasing over time. In this way, force feedback may be increased or reduced incrementally as the user’s stress goes in the opposite direction. Specifically, while the user becomes incrementally less stressed, the force feedback may be incrementally increased. As the user becomes incrementally more stressed, the force feedback may be incrementally reduced. However, also note that force feedback may be dynamically adjusted and variable based on other race metrics as well, including vehicle simulation vehicle velocity and tire traction, simulation road conditions, and simulation weather, which might cause momentary but large increases or reduction in radial force feedback (e.g., while still being inversely proportional to the user’s stress level)

From block 570 the logic may then proceed to block 580. At block 580 the device may save profile data for the end-user that was collected during the racing simulation to the user’s racing profile (or create a new racing profile first to then save the data to the profile). The profile data may include the user’s stress level(s) and other biometric data so that similar levels of radial resistance at the steering wheel may be applied in subsequent racing simulations from the start, with the radial resistance then being increased or decreased on the fly from there in the subsequent simulations. In this way, subsequent racing simulations may begin with a more-tailored experience for that particular user, rather than starting with a default amount of radial resistance for the steering wheel input device that might be dramatically too much or too little for that user.

Accordingly, it may be appreciated that in one example instance, the logic of FIG. 5 may be executed to identify, based on the one or more real-world biometrics of the person, a high stress level of the person in participating in the racing simulation (e.g., stress above a threshold amount) to then reduce radial force feedback at the steering wheel input device based on the high stress level of the person participating in the racing simulation. Also, the logic of FIG. 5 may be executed to increase radial force feedback at the steering wheel input device, possibly during the same racing simulation and in relation to the same person, based on the one or more real-world biometrics of that person indicating the user’s stress level going back down (e.g., below the stress threshold).

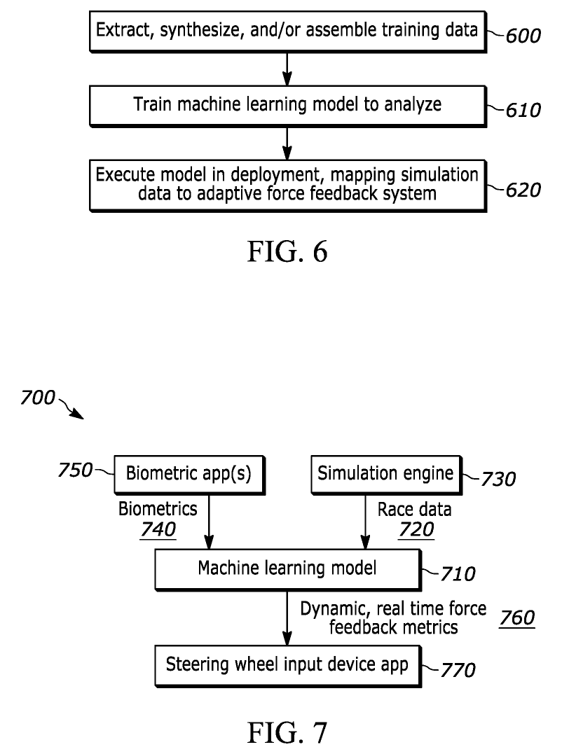

Now in reference to the example logic of FIG. 6, it is to be understood consistent with present principles that artificial intelligence (AI)-assisted data generation and processing may be used to accurately replicate the dynamic forces experienced during real-world racing scenarios while facilitating a simulation race. Thus, advanced AI systems can be employed to extract and synthesize comprehensive data from sources like real-world in-car footage, real-world telemetry logs, and real-world sensor readings. Machine learning models can be trained to analyze this multi-modal data to then identify intricate patterns and relationships between various inputs (e.g. steering/wheel angles, accelerator position, gear selection) and the corresponding forces exerted on the driver at the steering wheel. Thus, supervised learning, self-learning, unsupervised learning, reinforcement learning, and other deep learning techniques may be used to do so. This extracted data can then be mapped to the adaptive force feedback system during deployment, enabling an unparalleled degree of congruence between the virtual simulation and the experiences of real-life professional race drivers. The AI model’s ability to continuously learn and refine its inferences from an ever-expanding dataset can also ensure the system remains aligned with the latest real-world conditions and vehicle dynamics.

With this understanding in mind, note that the logic of FIG. 6 may be executed by a device configured to perform these functions. Accordingly, at block 600 the device may extract, synthesize, and/or assemble the aforementioned training data. Then at block 610 the device may train the machine learning (ML) AI-based model to analyze the data. Note that the model may be one suitable for pattern recognition, such as a convolutional neural network.

From block 610 the logic of FIG. 6 may then proceed to block 620. At block 620 the device may execute the ML model during deployment consistent with the logic of FIG. 5 and disclosure above in reference to FIG. 6. Thus, the device may map simulation data to an electronic race car’s adaptive force feedback system (e.g., steering wheel input device) according to its learning from real-world race scenarios.

Continuing the detailed description in reference to FIG. 7, this figure shows example software architecture 700 that may be implemented consistent with present principles. Accordingly, note that an ML model 710 according to FIG. 6 may receive race data 720 from a simulation engine 730 as well as receive human driver biometric data 740 from one or more biometric applications (apps) executing at one or more client devices that are themselves connected to biometric sensors engaged with the user to measure the user biometrics in real time as the virtual race transpires.

The ML model 710 may then analyze the data 720, 740 to provide an output 760 of dynamic, real-time force feedback metrics to apply to a hardware steering wheel input device (e.g., steering wheel 430) via a steering wheel input device app 770 executing at the electronic race car.

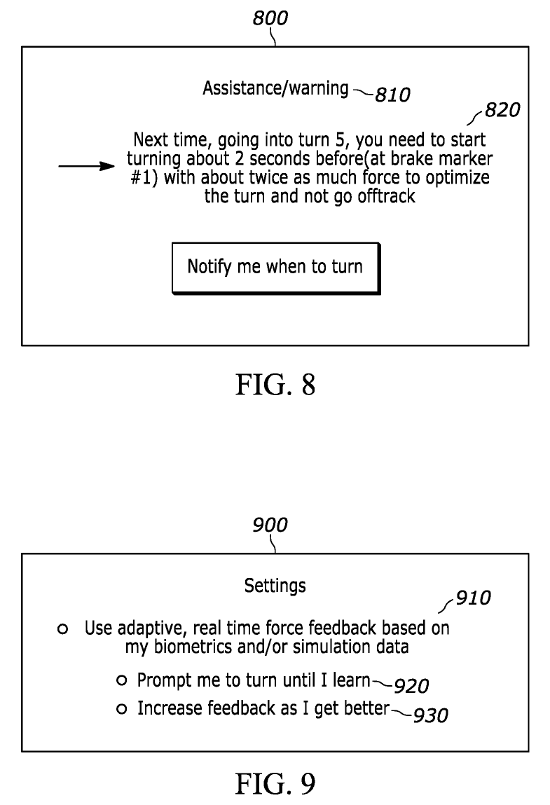

Now in reference to FIG. 8, an example graphical user interface (GUI) 800 is shown that may be presented on the display of an electronic race car, connected headset, connected smartphone, etc. consistent with present principles. The GUI 800 may be presented during a race simulation and/or responsive to the race simulation ending. The GUI 800 may indicate how the user can improve the user’s performance in playing the racing simulation in terms of steering using a steering wheel input device that provides radial resistance to the person turning the steering wheel input device as described herein. Accordingly, the GUI 800 may include an assistance prompt or warning 810 along with instructions 820.

The instructions 820 may be output by the ML model described above to provide a suggestion of how the user might improve their turning performance as part of the racing simulation to improve (shorten) the user’s race time in the simulation. Accordingly, in the present instance the instructions 820 may indicate the following: “Next time, going into turn #5, you need to start turning about two seconds before (at brake marker #1) with about twice as much force to optimize the turn and not go offtrack.”

It may thus be appreciated based on this that the ML model may infer and output suggestions to the user for the user to change the timing of a turn the user makes for a particular turn on the virtual racetrack, change the location of the turn the user makes for that turn on the virtual racetrack, and to change the amount of force with which the user turns the physical steering wheel to counteract or overcome radial resistance exerted by the simulation at the steering wheel.

In some examples, the GUI 800 may also include a selector 830. The selector 830 may be selectable to command the racing simulation to provide notifications to the user in the future the next time the user approaches the same turn so that the user can begin turning in accordance with the instructions 810. Thus, audible, visual, and/or tactile notifications may be provided during another lap in the same racing simulation instance and/or during another simulation instance in the future. In various examples, short bursts of tactile vibrations may be provided at the steering wheel input device in advance of the turn (e.g., a threshold distance or time before the turn). Additionally or alternatively, an audible tone may be presented to the user or a graphical “get ready to turn” marker may be presented on a display being used by the user to participate in the racing simulation.

Now in reference to FIG. 9, this figure shows an example GUI 900 that may be presented on a display for an end-user to configure one or more settings of an apparatus, racing simulation app, and/or electronic racecar to operate consistent with present principles. Each option discussed below may be selected by selecting the respective radio button shown adjacent to each option, whether through cursor input, touch input, or another type of input.

As shown in FIG. 9, the GUI 900 may include an option 910 that is selectable to set or configure the device to undertake present principles. Therefore, in one example, selection of the option 910 a single time may configure the device to, for multiple future racing simulations, execute the functions described above in reference to FIGS. 5-8. The option 910 may be accompanied by one or more sub-options 920, 930.

Selection of the sub-option 920 may set or configure the device to prompt the human driver to turn in accordance with the disclosure of FIG. 8 when approaching one or more turns of a virtual racetrack, at least until the user learns and begins turning at an optimal time and place with an optimal amount of force to optimize the virtual race car’s trajectory around that respective turn.

Sub-option 830 may be selected to set or configure the device to increase haptic feedback (radial resistance) as the user gets better at the racing simulation. Selection of this option 830 may therefore set the device to increase the radial resistance and hence challenge in playing the racing simulation/game in the future.

It may now be appreciated that racing simulations consistent with present principles provide nuanced physical feedback replicating the intricate forces experienced in an actual race car cockpit. Racecar steering wheels consistent with present principles may thus convincingly convey the multitude of sensations a real-life driver might feel through the steering wheel in a real-life race, which might include as subtle tire grip variations, distinct road surface textures, and instantaneous responsiveness to vehicle adjustments. This also allows drivers to transfer their skills from simulators to real-life racecars while also increasing the user’s physical engagement and learning potential, providing users vital cues to enhance their comprehension of real-world vehicle dynamics while increasing the simulations’ instructional and realism value for honing real-world driving proficiency. Increased driver safety is therefore also realized.

Thus, it may now be appreciated that present principles provide for an improved computer-based user interface that increases the functionality of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
facilitate a racing simulation;
as part of facilitating the racing simulation, adapt force feedback at a steering wheel input device in real time as the racing simulation transpires, the force feedback being adapted in real time based on one or more variable inputs associated with the racing simulation.

2. The device of claim 1, wherein the instructions are executable to:
adapt the force feedback at the steering wheel input device in real time as the racing simulation transpires by one of: reducing radial force feedback at the steering wheel input device, increasing radial force feedback at the steering wheel input device.

3. The device of claim 1, wherein the one or more variable inputs comprise simulation vehicle velocity.

4. The device of claim 1, wherein the one or more variable inputs comprise simulation vehicle tire traction.

5. The device of claim 4, wherein the simulation vehicle tire traction comprises tire slippage or tire drifting.

6. The device of claim 1, wherein the one or more variable inputs comprise one or more simulation road conditions.

7. The device of claim 6, wherein the one or more simulation road conditions comprise one or more of:
an asphalt road condition, a gravel road condition.

8. The device of claim 6, wherein the one or more simulation road conditions comprise one or more of: a wet surface road condition, an icy surface road condition.

9. The device of claim 1, wherein the one or more variable inputs comprise one or more real-world driver biometrics.

10. The device of claim 9, wherein the one or more real-world driver biometrics comprise one or more of:
heart rate, oxygen level, pupil dilation, body temperature.

11. The device of claim 1, wherein the one or more variable inputs comprise simulation weather.

12. The device of claim 11, wherein simulation weather comprises simulation wind impinging upon a simulation vehicle controlled by the steering wheel input device.

13. The device of claim 11, wherein simulation weather comprises simulation precipitation impinging upon a simulation vehicle controlled by the steering wheel input device.

14. The device of claim 1, comprising an electronic headset on which visual content related to the racing simulation is presented.

15. The device of claim 1, comprising an electronic race car in which a person can sit while playing the racing simulation.

16. A method, comprising:
facilitating a racing simulation at a device; and
as part of facilitating the racing simulation, adapting force feedback at a steering wheel input device as the racing simulation transpires, the force feedback being adapted during execution of the simulation based on one or more variable inputs associated with the racing simulation.

17. The method of claim 16, wherein the one or more variable inputs comprise one or more real-world biometrics of a person.

18. The method of claim 17, comprising:
identifying, based on the one or more real-world biometrics of the person, a stress level of the person in participating in the racing simulation; and
reducing, based on the stress level of the person participating in the racing simulation, radial force feedback at the steering wheel input device.

19. At least one computer readable storage medium (CRSM) that is not a transitory signal, the at least one CRSM comprising instructions executable by a processor system to:
facilitate a racing simulation at a device; and
as part of facilitating the racing simulation, change force feedback at a steering wheel input device as the racing simulation transpires, the force feedback being changed during execution of the simulation based on one or more variable inputs associated with the racing simulation.

20. The at least one CRSM of claim 19, wherein the one or more variable inputs comprise one or more real-world biometrics of a person participating in the racing simulation, and wherein the instructions are executable to:
increase, based on the one or more real-world biometrics of the person participating in the racing simulation, radial force feedback at the steering wheel input device.
